(19) United States
(12) Patent Application Publication
(10) Pub. No.: US 2018/0272593 A1
(43) Pub. Date: Sep. 27, 2018

(54) PHASE DIFFERENCE FILM, METHOD OF PRODUCING THE SAME, POLARIZING PLATE PROVIDED WITH PHASE DIFFERENCE FILM, AND LIQUID CRYSTAL DISPLAY DEVICE

(71) Applicant: FUJIFILM Corporation, Tokyo (JP)

(72) Inventors: Koji IIJIMA, Kanagawa (JP); Jun TAKEDA, Kanagawa (JP); Katsufumi OHMURO, Kanagawa (JP)

(73) Assignee: FUJIFILM Corporation, Tokyo (JP)

(21) Appl. No.: 15/991,479

(22) Filed: May 29, 2018

Related U.S. Application Data
(63) Continuation of application No. PCT/JP2016/004995, filed on Nov. 29, 2016.

(30) Foreign Application Priority Data
Nov. 30, 2015 (JP) 2015-234233

(51) Int. Cl. B29C 55/04; G02B 5/30; G02F 1/13363; G02F 1/1337; C08J 5/18

(52) U.S. Cl. CPC B29C 55/04; G02B 5/3083; B29K 2995/0034; G02F 1/1337; C08J 5/18; G02F 1/13363

(57) ABSTRACT

A phase difference film includes a liquid crystal layer in which a disk-like liquid crystal compound is fixed in a homeotropic alignment state, in which an in-plane retardation Re of the liquid crystal layer satisfies 200 nm≤Re≤300 nm and a retardation Rth in a thickness direction satisfies −30 nm≤Rth.

### CROSS-REFERENCE TO RELATED APPLICATIONS

This application is a continuation application of International Application No. PCT/JP2016/004995 filed Nov. 29, 2016, which was published under PCT Article 21(2) in Japanese, and which claims priority under 35 U.S.C. § 119(a) to Japanese Patent Application No. 2015-234233, filed Nov. 30, 2015. The above applications are hereby expressly incorporated by reference, in their entirety, into the present application.

### BACKGROUND OF THE INVENTION

### 1. Field of the Invention

The present invention relates to a phase difference film, a method of producing the same, a polarizing plate provided with a phase difference film, and a liquid crystal display device.

### 2. Description of the Related Art

In liquid crystal display devices of recent years, thinning has been advanced, and a trend toward this is remarkable particularly in liquid crystal display devices for television applications in which high added values such as high quality and large screens are required. In response thereto, thinning of each constitutional part is required. In particular, for members in a film form, such as polarizing plates and optical compensation films, optical films satisfying the requirement for thinning and simultaneously having suitable optical performance and mechanical physical properties are demanded.

It is found that since an in-plane switching (IPS) mode liquid crystal display device has a homogeneous alignment in which liquid crystal molecules are substantially parallel to the surface of a substrate in a non-driven state, light passes through a liquid crystal layer while making little changes in the polarizing surface, and as a result, by arranging polarizing plates above and below the substrate, a nearly perfect black display can be implemented in a non-driven state.

However, in the IPS mode liquid crystal display device, in a case where a panel is observed from a direction shifted from a normal direction, unavoidable light leakage due to the properties of the polarizing plate occurs in a direction shifted from the optical axis direction of the polarizing plates arranged above and below the liquid crystal cell, and thus, there arises a problem that the viewing angle is narrowed during black display and the contrast is degraded.

In order to solve the problem, in an IPS mode liquid crystal display device, a biaxial optical film having an Nz value given by Nz=(nx−nz)/(nx−ny) satisfying 0<Nz<1, that is, satisfying nx>nz>ny is proposed. Here, nx represents a refractive index in a film in-plane slow axis direction, ny represents a refractive index in a direction orthogonal to nx in the plane, and nz represents a main refractive index in a film thickness direction.

For example, in JP2004-4642A, an optical film in which a polarizing plate and a phase difference film are laminated, an Nz value satisfies 0.4 to 0.6, and an in-plane phase difference Re is 200 to 350 nm is proposed. However, specifically, the phase difference film of JP2004-4642A is a polycarbonate film that is required to have a film thickness of 65 μm to obtain an in-plane phase difference Re of 260 nm, and it is difficult to meet a demand for thinning of a liquid crystal display device.

In addition, biaxial optical films obtained by stretching a thermoplastic polymer film satisfying nz>nx≅ny are disclosed in JP2006-3715A and JP2009-288440A.

JP2006-3715A discloses that a thermoplastic polymer film formed by a casting method or an extrusion method is stretched to obtain a biaxial optical film.

In addition, JP2009-288440A discloses that a biaxial optical film can be produced with high yield by stretching a thermoplastic polymer film provided with a layer in which a positive uniaxial liquid crystal composition is fixed in a homeotropic alignment state on a cycloolefin-based film substrate or a triacetylcellulose-based film substrate.

### SUMMARY OF THE INVENTION

However, regarding the biaxial optical film of JP2006-3715A, in order to obtain a currently required in-plane phase difference Re value, it is required to increase the film thickness. Also, regarding the biaxial optical film of JP2009-288440A, the specific example thereof is a film obtained by stretching a laminate having a thickness of 110 μm by 20%. From the viewpoint of thinning, a phase difference film capable of suppressing light leakage during the black display with a smaller film thickness is required.

The present invention has been made in consideration of the above circumstances and an object thereof is to provide a phase difference film having a small thickness and capable of suppressing light leakage during black display and a method of producing the same.

Another object of the present invention is to provide a polarizing plate and a liquid crystal display device having a small thickness and exhibiting an excellent effect of suppressing light leakage during black display.

A phase difference film of the present invention comprises: a liquid crystal layer in which a disk-like liquid crystal compound is fixed in a homeotropic alignment state, in which an in-plane retardation Re of the liquid crystal layer satisfies 200 nm≤Re≤300 nm and a retardation Rth thereof in a thickness direction satisfies −30 nm≤Rth.

The phase difference film of the present invention is produced by a method of producing a phase difference film of the present invention, which will be described later.

In the present specification, Re represents an in-plane phase difference of a phase difference film at a wavelength of 550 nm and is a value represented by Re=(nx−ny)×d, and Rth represents a phase difference of a phase difference film in a thickness direction at a wavelength of 550 nm and is a value represented by Rth=((nx+ny)/2−nz)×d. nx represents a refractive index in a film in-plane slow axis direction, ny represents a refractive index in a direction orthogonal to nx in the plane, and nz represents a main refractive index in a film thickness direction.

In the phase difference film of the present invention, in an aspect in which the liquid crystal layer is provided on a cellulose acylate film base material, an Nz coefficient may satisfy 0.50≤Nz.

In the present specification, the Nz coefficient is a value given by Nz=(nx−nz)/(nx−ny).

It is preferable that the disk-like liquid crystal compound includes Compound 101 or Compound 102.

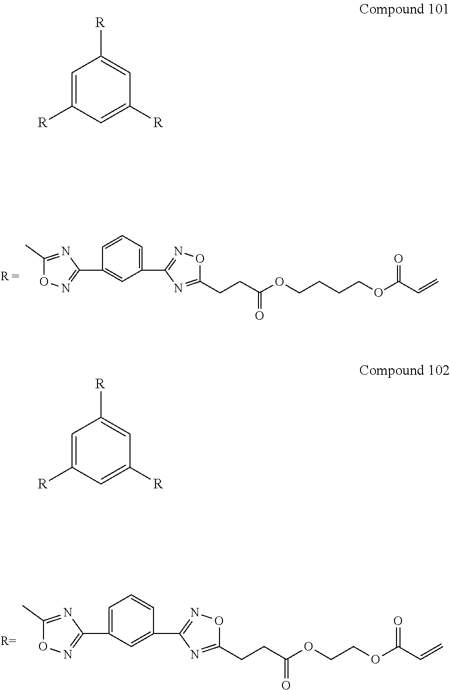

A method of producing a phase difference film of the present invention comprises: a liquid crystal layer precursor layer forming step of forming a liquid crystal alignment film in which a disk-like liquid crystal compound is aligned in a homeotropic manner and then fixing the disk-like liquid crystal compound to form a liquid crystal layer precursor layer; and a stretching step of stretching the liquid crystal layer precursor layer in a slow axis direction.

In the present specification, the term “slow axis” means a direction in which the refractive index becomes the maximum in the plane of the liquid crystal alignment film or the phase difference film. The slow axis can be measured by making light having a wavelength of λ nm to be incident onto a film in a direction normal to the film using KOBRA 21ADH (manufactured by Oji Scientific Instruments).

It is preferable that in the stretching step, a stretching ratio is 1.28 to 1.40 times.

In addition, it is preferable that in the stretching step, the stretching is performed by setting a film surface temperature of the liquid crystal layer precursor layer to be equal to or higher than a glass transition temperature and equal to or lower than a melting temperature of the liquid crystal layer precursor layer.

In the present specification, the term “film surface temperature” means a temperature measured within a distance of 100 mm from the film surface in a noncontact manner.

It is preferable that in the liquid crystal layer precursor layer forming step, the disk-like liquid crystal compound includes Compound 101 or Compound 102.

A polarizing plate of the present invention comprises the phase difference film of the present invention.

A liquid crystal display device of the present invention comprises the polarizing plate of the present invention.

In the present specification, the term “polarizing plate” is used in a sense of including both a long polarizing plate and a polarizing plate cut in a size to be incorporated in a display device unless otherwise specified. Herein, the term “cutting” includes “punching”, “cutting out”, and the like.

According to the present invention, there is provided a phase difference film includes a liquid crystal layer in which a disk-like liquid crystal compound is fixed in a homeotropic alignment state, an in-plane retardation Re of the liquid crystal layer satisfies 200 nm≤Re≤300 nm, and a retardation Rth in a thickness direction satisfies −30 nm≤Rth. The phase difference film according to the present invention satisfying the retardation values is capable of suppressing light leakage in a thin film formed of only a base material-less liquid crystal layer in a case where a panel is observed from a direction shifted from a normal direction in an in-plane switching (IPS) mode liquid crystal display device and effectively suppressing contrast degradation during black display.

### BRIEF DESCRIPTION OF THE DRAWINGS

FIG. 1 is a schematic cross-sectional view showing phase difference films according to first and second embodiments of the present invention.

FIG. 2A is an image diagram showing index ellipsoids of a precursor film (before stretching) and a phase difference film (after stretching) according to one embodiment of the present invention.

FIG. 2B is a schematic cross-sectional view showing the configurations of the phase difference film and the precursor film shown in FIG. 2A in a longitudinal direction.

FIG. 2C is a schematic cross-sectional view showing the configurations of the phase difference film and the precursor film shown in FIG. 2A in a width direction.

FIG. 3 is a schematic top view showing a part of pixel electrodes in the inner surface of a substrate of an IPS type liquid crystal cell.

FIG. 4 is a schematic cross-sectional view showing the configuration of an IPS type liquid crystal display device including a polarizing plate according to one embodiment of the present invention.

### DESCRIPTION OF THE PREFERRED EMBODIMENTS

First, in the present specification, Re represents a value measured by making light having a wavelength of 550 nm to be incident onto a film in a direction normal to the film using KOBRA 21ADH or WR (product name, manufactured by Oji Scientific Instruments).

In a case where a film to be measured is one expressed by a uniaxial or biaxial index ellipsoid, Rth is calculated in the following manner.

Rth is measured by the following method. Re is measured at six points in total by making light having a wavelength of λ nm to be incident onto a film in respective directions tilted from a direction normal to the film with an in-plane slow axis (which is determined with KOBRA 21ADH or WR) as a tilt axis (rotation axis) to 50 degrees on one side of the film in the normal direction with a step of 10 degrees, and Rth is calculated with KOBRA 21ADH or WR based on the retardation values thus measured, the assumed value of the average refractive index, and the input film thickness value.

In the above description, in a case of a film that has a direction in which the retardation value thereof is zero at a certain tilt angle relative to the in-plane slow axis thereof in the normal direction taken as a rotation axis, the retardation value at a tilt angle larger than the tilt angle is converted into the corresponding negative value and then calculated by KOBRA 21ADH or WR.

Additionally, with the slow axis taken as the tilt axis (rotation axis) (in the case in which the film does not have a slow axis, an arbitrary in-plane direction of the film may be taken as the rotation axis), the retardation values are measured in two arbitrary tilted directions and, based on the above values, the assumed value of the average refractive index, and the inputted film thickness, Rth can be also calculated according to Equations (1) and (2).

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Equation ( 1 ) \\ Rth = ( \frac{nx + ny}{2} - nz ) \times d & Equation ( 2 )\end{matrix}$$

In the equations, Re(θ) represents a retardation value in a direction tilted by an angle θ from a normal direction. In particular, in a case there is no description of θ, θ represents 0°. nx represents a refractive index in an in-plane slow axis direction, ny represents a refractive index in a direction orthogonal to nx in the plane, and nz represents a refractive index in a direction orthogonal to nx and ny. d represents a film thickness.

In the case in which the film to be measured cannot be expressed by a uniaxial or biaxial index ellipsoid, that is, the film that does not have a so-called optic axis, Rth is calculated in the following manner.

Rth is measured by the following method. Re is measured at eleven points by making light having a wavelength of 550 nm to be incident onto the film in respective tilt directions of from −50 degrees to +50 degrees with a step of 10 degrees with respect to the direction normal to the film with the in-plane slow axis (which is determined with KOBRA 21ADH or WR) taken as a tilt axis (rotation axis), and Rth is calculated with KOBRA 21ADH or WR based on the retardation values thus measured, the assumed value of the average refractive index, and the input film thickness value.

In the above measurements, the assumed value of the average refractive index may be the values shown in Polymer Handbook (JOHN WILEY & SONS, INC) and the brochures of various optical films. For the film with an unknown average refractive index value, the film may be measured for the average refractive index with an Abbe refractometer. Examples of the average refractive index values of the major optical films are shown below; cellulose acylate (1.48), cycloolefin polymer (1.52), polycarbonate (1.59), polymethyl methacrylate (1.49), and polystyrene (1.59). By inputting the assumed value of the average refractive index and the film thickness, the values of nx, ny and nz are calculated with KOBRA 21ADH or WR. The Equation of Nz=(nx−nz)/(nx−ny) is further calculated based on the calculated values of nx, ny and nz.

The retardations Re and Rth can be measured using Axo Scan (manufactured by AXOMETRICS Inc.) and Nz can be obtained by Nz=Rth/Re+0.5.

┌Phase Difference Film and Method of Producing the Same┘

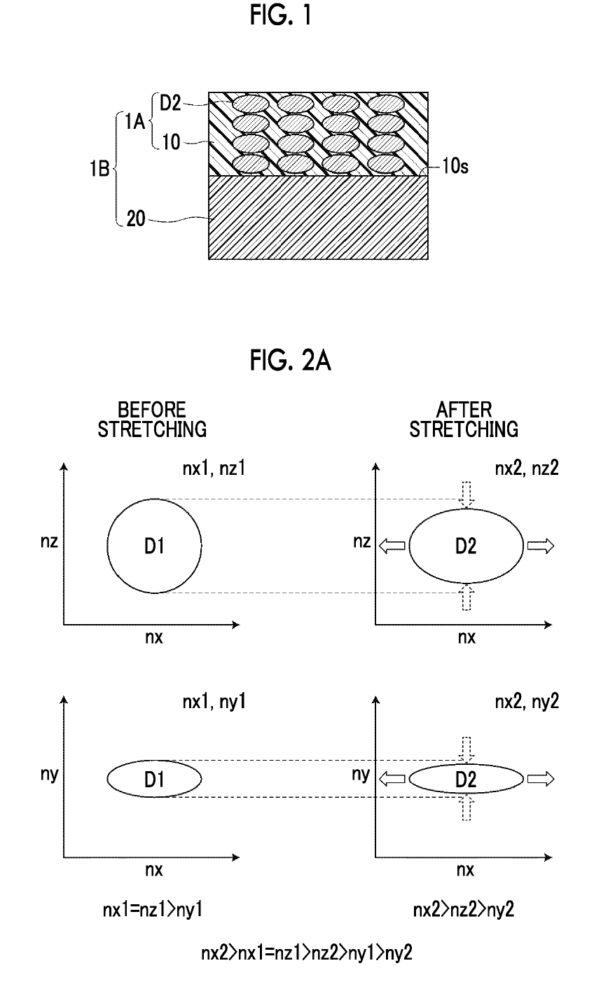

With reference to the drawings, phase difference films according to embodiments of the present invention will be described. FIG. 1 is a schematic cross-sectional view showing configurations of a phase difference film 1A according to a first embodiment and a phase difference film 1B according to a second embodiment. In the drawings of the present specification, the scale of each portion is appropriately changed and shown for allowing easy viewing.

In the present specification, numerical value ranges expressed by “to” mean that the numerical values described before and after “to” are included as a lower limit and an upper limit, respectively. In addition, it is defined that the terms “orthogonal” and “parallel” with respect to an angle mean ranges expressed by precise angle ±10°, and the terms “equal” and “different” with respect to an angle can be determined based on a criterion that whether the difference is less than 5° or not.

A phase difference film 1A of a first embodiment and a phase difference film 1B of a second embodiment each include a liquid crystal layer 10 in which a disk-like liquid crystal compound is fixed in a homeotropic alignment state, an in-plane retardation Re of the liquid crystal layer 10 satisfies 200 nm≤Re≤300 nm, and a retardation Rth in a thickness direction satisfies −30 nm≤Rth. While the phase difference film 1A of the first embodiment includes the liquid crystal layer 10, the phase difference film 1B of the second embodiment is provided with the liquid crystal layer 10 on a base material 20.

In FIG. 1, regarding the ellipse indicated by reference numeral D2, the optical properties of the liquid crystal layer are schematically shown as index ellipsoids.

The liquid crystal layer 10 is a layer in which a disk-like liquid crystal compound is fixed in a homeotropic alignment state. In the present specification, the homeotropic alignment means that the director of the alignment layer of the disk-like liquid crystal compound is directed to a direction in which the absolute value of the elevation angle with respect to the coated surface is less than 10 degrees. In this case, the angle of the director is a vertical angle with accuracy with which the absolute value of the polar angle of the mesogen group in the disk-like liquid crystal compound with respect to the coated surface is less than 10 degrees. The angle of the director of the alignment layer can be confirmed by performing three-dimensional birefringence measurement at a wavelength of 550 nm using an automatic birefringence meter KOBRA-WR (manufactured by Oji Scientific Instruments).

The liquid crystal layer 10 is not particularly limited as long as the layer is a layer in which a disk-like liquid crystal compound is fixed in a homeotropic alignment state. However, it is preferable that the liquid crystal layer is a resin layer. In the present specification, the liquid crystal layer 10 means a layer having a mesogen group exhibiting liquid crystallinity and the liquid crystal layer 10 itself may have liquid crystallinity or may not have liquid crystallinity.

The film thickness of the liquid crystal layer 10 is preferably 0.5 to 5.0 μm and more preferably 1.0 to 3.0 μm.

As shown in FIG. 1, an index ellipsoid D2 schematically shown as an optical property of the liquid crystal layer 10 has a shape pressed in a vertical direction. The retardation Re value in the horizontal direction and the retardation Rth value in the thickness direction of the liquid crystal layer 10 can be obtained by expressing the optical properties of each portion as index ellipsoids pressed in the vertical direction shown in FIG. 1.

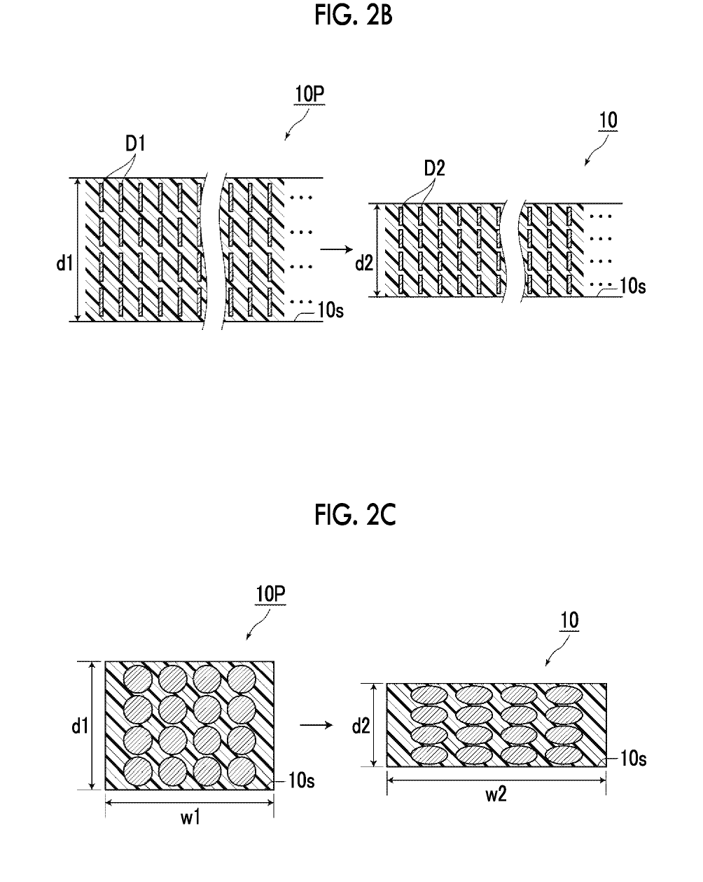

As shown in FIG. 2A, for example, the liquid crystal layer 10 (index ellipsoid D2) can be formed by stretching a liquid crystal layer precursor layer 10P (index ellipsoid D1), which is formed by aligning the disk-like liquid crystal compound in a homeotropic manner and fixing (polymerizing) the disk-like liquid crystal compound, in the radial direction of the ellipsoid, that is, in a slow axis direction under heating.

FIG. 2A schematically shows a change in shape of the index ellipsoid before and after heat stretching in a case where the phase difference film 1A (liquid crystal layer 10) is produced by a roll-to-roll process by a coating method suitable for the production of the phase difference film 1A. In addition, FIGS. 2B and 2C are schematic cross-sectional views respectively showing the configurations of the liquid crystal layer precursor layer 10P and the liquid crystal layer 10 shown in FIG. 2A cut in a direction parallel to the film handling direction and in a direction parallel to the film width direction. In FIGS. 2B and 2C, 10s represents the bottom of the liquid crystal layer 10.

As schematically shown in FIG. 2A, in the index ellipsoid D1 before stretching, a refractive index nz1 in a thickness direction (z) and a refractive index nx1 in a film slow axis direction (x) are isotropic (nx1=nz1), and a refractive index ny1 in a direction (y) orthogonal to the slow axis direction in the plane of the film is smaller than the refractive index nx1 in the film slow axis direction (x) (nx1>ny1). That is, the relationship of nx1, ny1, and nz1 in the index ellipsoid D1 is nx1=nz1>ny1.

By applying a force to the index ellipsoid by stretching in the arrow direction indicated by a broken line in the drawing (the vertical direction in the drawing), the index ellipsoid D2 stretched in the arrow direction indicated by a solid line (the horizontal direction in the drawing) is obtained. In the index ellipsoid D2 after stretching, a refractive index nz2 in a thickness direction (z) is smaller than a refractive index nx2 in a film slow axis direction (x) (nx2>nz2), a refractive index ny2 in a direction (y) orthogonal to the slow axis direction in the plane of the film is smaller than the refractive index ny1 of the index ellipsoid D1, and the refractive index nx2 in the film slow axis direction (x) is larger than the refractive index nx of the index ellipsoid D1. The relationship of nx2, ny2, and nz2 the index ellipsoid D2 is nx2>nz2>ny2.

Accordingly, the relationship of refractive indexes before and after stretching is nx2>nx1>=nz1>nz2>ny1>ny2.

The details of the production method will be described. However, in a case where the phase difference film is produced by a roll-to-roll process, from the viewpoint of easiness of process, it is preferable that the disk-like liquid crystal compound is aligned in a homeotropic manner such that the radial direction of the mesogen group of the disk-like liquid crystal compound and the film width direction orthogonal to the film handling direction are parallel to each other, and is further fixed (polymerized) to form the liquid crystal layer precursor layer 10P. The liquid crystal layer precursor layer 10P formed by the alignment of the mesogen group of the disk-like liquid crystal compound becomes a homeotropic alignment liquid crystal layer formed by substantially matching the slow axis direction with the film width direction.

In a case where the liquid crystal layer precursor layer 10P is subjected to heat stretching in the slow axis direction such that a film width w1 is changed to w2, a film thickness d1 of the liquid crystal layer precursor layer 10P is decreased to a film thickness d2 by stretching. As a result, the index ellipsoid D is changed to the index ellipsoid D2 pressed in the film thickness direction. Due to this change, the liquid crystal layer 10 in which the in-plane retardation Re satisfies 200 nm≤Re≤300 nm and the retardation Rth in the thickness direction satisfies −30 nm≤Rth can be obtained.

That is, the phase difference film 1A (liquid crystal layer 10) can be produced by a method of producing a phase difference film according to the present invention including a liquid crystal layer precursor layer forming step of forming a liquid crystal alignment film in which a disk-like liquid crystal compound is aligned in a homeotropic manner and then fixing the disk-like liquid crystal compound to form a liquid crystal layer precursor layer 10P, and a stretching step of stretching the liquid crystal layer precursor layer 10P in the slow axis direction. In the stretching step of the method of producing a phase difference film according to the present invention, the stretching of the liquid crystal layer precursor layer may be performed in a case where the liquid crystal layer precursor layer is provided on the base material 20 or in a case where only the liquid crystal layer precursor layer is provided. The stretching is preferably performed by setting the film surface temperature of the liquid crystal layer precursor layer to be equal to or higher than the glass transition temperature and equal to or lower than the melting temperature of the liquid crystal layer precursor layer.

A stretching ratio w2/w1 in the stretching step is not particularly limited as long as the Re value and the Rth values are satisfied. However, as shown in the following examples, by setting the stretching ratio w2/w1 to 1.28 to 1.40 times, the Re value and the Rth values are satisfied and thus the effect of suppressing light leakage during black display can be obtained.

The disk-like liquid crystal compound is not particularly limited as long as the disk-like liquid crystal compound is a liquid crystal compound in which the skeleton of the mesogen group has a disk-like shape, such as compounds shown in Table 1 which will be described later. However, the disk-like liquid crystal compound is preferably a polymerizable liquid crystal compound having a polymerizable group and capable of forming a resin layer having thermoplasticity after the mesogen group is fixed by polymerization. Examples of the polymerizable group include an acryloyl group, a methacryloyl group, an epoxy group, and a vinyl group. By curing the polymerizable liquid crystal compound, the alignment of the liquid crystal compound can be fixed. In a case where the disk-like liquid crystal compound is a liquid crystal compound having a polymerizable group, the disk-like liquid crystal compound is preferably a relatively low molecular weight liquid crystal compound having a degree of polymerization of less than 100.

As the disk-like liquid crystal compound, for example, compounds described in JP2007-108732A and JP2010-244038A are preferable and compounds shown in Table 1 are more preferable. Among these, the disk-like liquid crystal compound particularly preferably includes Compound 101 or Compound 102.

TABLE 1
Disk-like liquid crystal compound

| | |
|---|---|
| 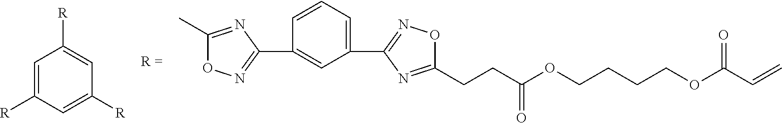 | Compound 101 |
| 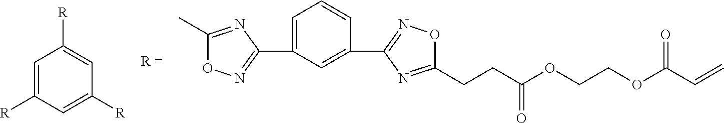 | Compound 102 |
| 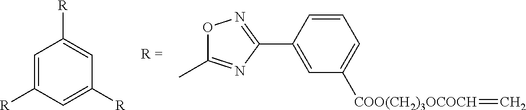 | Compound 1 |
| 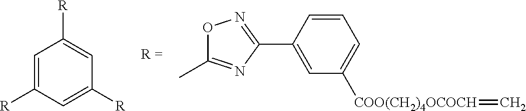 | Compound 2 |

In a case where a liquid crystal compound not having a polymerizable group is used as the disk-like liquid crystal compound, the liquid crystal layer 10 may adopt an aspect in which the disk-like liquid crystal compound is aligned in a homeotropic manner and fixed in a binder having thermoplasticity.

In the phase difference film 1A formed of the liquid crystal layer 10 having the above configuration, as described above, the in-plane retardation Re satisfies 200 nm≤Re≤300 nm and the retardation Rth in the thickness direction satisfies −30 nm≤Rth. Thus, an excellent effect of suppressing light leakage during black display can be obtained. As shown in the following examples, the phase difference film 1A formed of the liquid crystal layer 10 can be formed as a thin film having a small thickness of several μm. Accordingly, naturally, in a case of using only the liquid crystal layer 10, and also in a case where the liquid crystal layer is attached to the base material and used, the film thickness of the base material can be minimized. Thus, the use of the phase difference film can greatly contribute to thinning of a liquid crystal display device.

As described above, the phase difference film 1A includes the liquid crystal layer 10 in which the disk-like liquid crystal compound D2 is fixed in a homeotropic alignment state, the in-plane retardation Re of the liquid crystal layer 10 satisfies 200 nm≤Re≤300 nm, and the retardation Rth in the thickness direction satisfies −30 nm≤Rth. The phase difference film 1A satisfying the retardation values is capable of suppressing light leakage and effectively suppressing contrast degradation during black display in a thin film of only a base material-less liquid crystal layer 10 in a case where a panel is observed from a direction shifted from the normal direction in an IPS mode liquid crystal display device, as shown in the following examples.

The most effective advantage of the phase difference film 1A compared to a phase difference film of the related art is a wide range of selection of the base material having the above thickness. The light leakage suppressing effect during black display obtained in the phase difference film of the related art is less likely to make little contribution to retardation of the base material. In contrast, since an excellent light leakage suppressing effect can be obtained with only the liquid crystal layer excluding the base material in the phase difference film 1A, the material and the film thickness of the base material can be selected without considering the contribution to retardation. Further, by providing the phase difference film 1A on the base material having optical properties contributing to retardation as the liquid crystal layer 10, a higher light leakage suppressing effect during black display can be obtained.

The phase difference film 1B of the second embodiment shown in FIG. 1 includes the liquid crystal layer 10 on the base material 20.

As the base material 20, glass or a polymer film can be used. Examples of materials for the polymer film used as the base material include a cellulose acylate film (for example, a cellulose triacetate film (refractive index: 1.48), a cellulose diacetate film, a cellulose acetate butyrate film, and a cellulose acetate propionate film), a polyolefin such as polyethylene and polypropylene, a polyacrylic resin film such as polymethyl methacrylate, a polyurethane-based resin film, a polycarbonate film, a polyether film, a polymethyl pentane film, a polyether ketone film, a (meth)acrylnitrile film, a polymer having an alicyclic structure (norbornene-based resin, (product name “ARTON (registered trademark))”, manufactured by JSR Corporation), and amorphous polyolefin (product name “ZEONEX (registered trademark)”, manufactured by ZEON CORPORATION)). Among these, cellulose acylate and a polymer having the alicyclic structure are preferable, and cellulose acylate is particularly preferable.

These base materials may be used in the form of a uniaxially or biaxially stretched base material to further contribute to suppressing light leakage.

As shown in the following examples, in an aspect in which a uniaxially stretched film of triacetylcellulose is used as the base material 20 and the liquid crystal layer 10 is provided thereon, the Nz coefficient can satisfy 0.50≤Nz and a higher light leakage suppressing effect can be obtained.

The film thickness of the base material 20 is preferably 10 μm to 60 μm and more preferably 20 μm to 40 μm.

Hereinafter, each step of the method of producing a phase difference film of the present invention will be described. As described above, the method of producing a phase difference film of the present invention include a liquid crystal layer precursor layer forming step of forming a liquid crystal alignment film in which the disk-like liquid crystal compound D is aligned in a homeotropic manner and then fixing the disk-like liquid crystal compound to form a liquid crystal layer precursor layer 10P, and a stretching step of stretching the liquid crystal layer precursor layer 10P in a slow axis direction.

<Liquid Crystal Layer Precursor Layer Forming Step>

The liquid crystal layer precursor layer 10P is preferably formed by applying a liquid crystal composition capable of forming the liquid crystal layer precursor layer 10P obtained by aligning the disk-like liquid crystal compound in a homeotropic manner as described above to a temporary support or to the base material 20 in the production of the phase difference film 1B of the second embodiment, aligning the disk-like liquid crystal compound in a homeotropic manner, then aging the alignment, and curing the applied composition.

The liquid crystal composition may include the above-described disk-like liquid crystal compound and various additives for satisfactorily fixing the disk-like liquid crystal compound in a homeotropic alignment state. Examples of the additives include a polymerization initiator, a surfactant, an alignment auxiliary agent, and a solvent. In addition, in a case where the disk-like liquid crystal compound does not have polymerizability, the liquid crystal composition may include a binder or a monomer thereof.

—Polymerization Initiator—

In a case where the coated film is cured by polymerizing a polymerizable compound, such as a case where the disk-like liquid crystal compound is a polymerizable liquid crystal compound, or the like, the liquid crystal composition preferably includes a polymerization initiator.

Examples of the polymerization initiator include α-carbonyl compound (described in U.S. Pat. No. 2,367,661A and U.S. Pat. No. 2,367,670A), acyloin ethers (described in U.S. Pat. No. 2,448,828A), α-hydrocarbon substituted aromatic acyloin compounds (described in U.S. Pat. No. 2,722,512A), polynuclear quinone compounds (described in U.S. Pat. No. 3,046,127A and U.S. Pat. No. 2,951,758A), combinations of triarylimidazole dimers and p-aminophenyl ketones (described in U.S. Pat. No. 3,549,367A), acridine and phenadine compounds (described JP1985-105667A (JP-S60-105667A) and U.S. Pat. No. 4,239,850A), oxadiazole compounds (described in U.S. Pat. No. 4,212,970A), and acylphosphine oxide compounds (described in JP1988-40799B (JP-S63-40799B), JP1993-29234B (JP-H05-29234B), and JP1998-95788A (JP-H10-95788A), and JPi998-29997A (JP-H10-29997A)).

—Solvent—

The liquid crystal composition preferably includes a solvent. The solvent may be a low surface tension solvent or may be a standard surface tension solvent. Among these, it is preferable that the composition for forming a liquid crystal layer contains a low surface tension solvent.

The surface tension of the low surface tension solvent is 10 to 22 mN/m (10 to 22 dyn/cm), preferably 15 to 21 mN/m, and more preferably 18 to 20 mN/m. The surface tension of the standard surface tension solvent is greater than 22 mN/m, preferably 23 to 50 mN/m, and more preferably 23 to 40 mN/m.

In addition, a difference between the surface tension of the low surface tension solvent and the surface tension of the standard surface tension solvent is preferably 2 mN/m or greater, more preferably 3 mN/m or greater, even more preferably 4 to 20 mN/m, and particularly preferably 5 to 15 mN/m.

In the present specification, the surface tension of the solvent is a value described in Solvent Handbook (published by Kodansha Ltd., 1976). For example, the surface tension of the solvent is a physical property value that can be measured with an automatic surface tensiometer CBVP-A3 manufactured by Kyowa Interface Science, Co., Ltd. The measurement may be carried out at a condition of 25° C.

As the solvent, organic solvents are preferably used, and among these solvents, a low surface tension solvent and a standard surface tension solvent can be selected. Examples of the organic solvents include alcohols (for example, ethanol and tert-butyl alcohol), amides (for example, N,N-dimethylformamide), sulfoxides (for example, dimethylsulfoxide), heterocyclic compounds (for example, pyridine), hydrocarbons (for example, heptane, cyclopentane, toluene, hexane, and tetrafluoroethylene), alkyl halides (for example, chloroform, and dichloromethane), esters (for example, methyl acetate, butyl acetate, and isopropyl acetate), ketones (for example, acetone, methyl ethyl ketone, and cyclohexanone), ethers (for example, tetrahydrofuran and 1,2-dimethoxyethane), and amines (for example, triethylamine). Two or more organic solvents may be used in combination. The solvent which is used as a solvent at the time of performing polymerization can be used as the solvent of the composition without being removed (for example, toluene).

Examples of the low surface tension solvent include tert-butyl alcohol (19.5 mN/m), tetrafluoroethylene (TFE, 20.6 mN/m), triethylamine (20.7 mN/m), cyclopentane (21.8 mN/m), heptane (19.6 mN/m), and a mixed solvent obtained by combining any two or more of these solvents. The numerical value indicates the surface tension. Among these, from the viewpoint of safety, tert-butylalcohol, tetrafluoroethylene, triethylamine, or cyclopentane is preferable, tert-butylalcohol or tetrafluoroethylene is more preferable, and tert-butylalcohol is even more preferable.

Examples of the standard surface tension solvent include methyl ethyl ketone (MEK, 23.9 mN/m), methyl acetate (24.8 mN/m), methyl isobutyl ketone (MIBK, 25.4 mN/m), cyclohexanone (34.5 mN/m), acetone (23.7 mN/m), isopropyl acetate (0.0221 mN/m), and a mixed solvent obtained by combining any two or more of these solvents. The numerical value indicates the surface tension. Among these, a mixed solvent of methyl ethyl ketone, cyclohexanone, and another solvent, a mixed solvent of methyl acetate and methyl isobutyl ketone, or the like is preferable.

The concentration of the solvent with respect to the total mass of the liquid crystal composition is preferably 95% to 50% by mass, more preferably 93% to 60% by mass, and even more preferably 90% to 75% by mass.

In a drying step in a case where the liquid crystal layer is formed, 95% by mass or more of the solvent of the liquid crystal composition with respect to the total amount of the solvent is preferably removed, 98% by mass or more of the solvent of the liquid crystal composition with respect to the total amount of the solvent is more preferably removed, 99% by mass or more of the solvent of the liquid crystal composition with respect to the total amount of the solvent is even more preferably removed, substantially 100% by mass of the solvent of the liquid crystal composition with respect to the total amount of the solvent is particularly preferably removed.

(Formation of Liquid Crystal Layer)

The liquid crystal layer may be a layer formed by applying the liquid crystal composition to a surface of a support to which alignment controllability is imparted, aligning the molecules of the liquid crystal compound, and drying the obtained coated film, or may be a layer formed by further performing a curing step by light irradiation, heating, or the like.

In order to form the liquid crystal layer 10 obtained by aligning the disk-like liquid crystal compound in a homeotropic manner on a temporary support or the base material 20 (hereinafter, both collectively referred to as a support in some cases), it is required that the surface of the support on which the liquid crystal layer is to be formed has alignment controllability that the disk-like liquid crystal compound can be aligned in a homeotropic manner. A method of imparting alignment controllability to the surface of the support is not particularly limited and a method of providing an alignment film on the surface of the support or a method of subjecting the surface of the support to a direct alignment treatment (for example, rubbing treatment) may be used. As a support that can be subjected to a direct alignment treatment, for example, a PET film base material or the like can be used.

An alignment layer can be provided on the support by means such as a rubbing treatment of an organic compound (preferably a polymer), oblique vapor deposition of an inorganic compound such as silicon oxide, and formation of a layer including a microgroove. Further, an alignment layer is also known in which an alignment function is generated by applying an electric field, by applying a magnetic field, or by performing light irradiation. As the alignment layer, a rubbing treatment alignment layer and a photo alignment layer which are used by performing a rubbing treatment are preferable. As the alignment layer suitable for the homeotropic liquid crystal layer, for example, the descriptions of JP2014-38143A and JP2014-032434A can be referred to.

The liquid crystal composition can be applied by a method or the like in which the liquid crystal composition is spread by using a suitable method such as a roll coating method, a gravure printing method, and a spin coating method. Further, the liquid crystal composition can be applied by various methods such as a wire bar coating method, an extrusion coating method, a direct gravure coating method, a reverse gravure coating method, and a die-coating method. In addition, the composition can be jetted from a nozzle by using an ink jet device, and thus, the coated film can also be formed.

The drying may be performed by being left to stand, or may be performed by being heated. In the drying step, an optical function derived from a liquid crystal component may be exhibited. For example, in a case where the liquid crystal component contains a liquid crystal compound, the liquid crystalline phase may be formed in a process where a solvent is removed by drying. The liquid crystalline phase may be formed by setting the temperature to a transition temperature of a liquid crystalline phase by heating. For example, first, heating is performed to a temperature of an isotropic phase, and after that, cooling is performed to the transition temperature of the liquid crystalline phase, and thus, the state of the liquid crystalline phase can be stably obtained. The transition temperature of the liquid crystalline phase is preferably in a range of 10° C. to 250° C., and is more preferably in a range of 10° C. to 150° C., from the viewpoint of manufacturing suitability or the like. In a case where the transition temperature of the liquid crystalline phase is lower than 10° C., a cooling step or the like is necessary to lower the temperature to a temperature range in which the liquid crystalline phase is exhibited. In addition, in a case where the transition temperature of the liquid crystalline phase is higher than 200° C., first, a high temperature is necessary to obtain an isotropic liquid state at a temperature higher than the temperature range in which the liquid crystalline phase is exhibited, and thus, it is disadvantageous from the viewpoint of waste of thermal energy, deformation or modification of a substrate, and the like.

For example, in a case where the liquid crystal component contains a polymerizable compound, it is preferable that the film after being dried described above is cured. In a case where the liquid crystal component contains a polymerizable liquid crystal compound, it is possible to maintain and fix the alignment state of the molecules of the liquid crystal compound by curing. The curing can be performed by a polymerization reaction of a polymerizable group in the polymerizable compound.

The polymerization reaction includes a thermal polymerization reaction using a thermal polymerization initiator and a photopolymerization reaction using a photopolymerization initiator. The photopolymerization reaction is preferable. In light irradiation for polymerizing the polymerizable compound, in particular, the polymerizable liquid crystal compound, an ultraviolet ray is preferably used. Irradiation energy is preferably 50 mJ/cm² to 1,000 J/cm², and is more preferably 100 to 800 mJ/cm². In order to accelerate the photopolymerization reaction, the light irradiation may be performed under heating conditions.

In order to accelerate a curing reaction, ultraviolet irradiation may be performed under heating conditions. In addition, the oxygen concentration in the atmosphere is relevant to a degree of polymerization, and thus, in a case where a desired degree of polymerization is not obtained in the air, and film hardness is insufficient, it is preferable to decrease the oxygen concentration in the atmosphere by a method of nitrogen substitution or the like. The oxygen concentration is preferably 10% or less, more preferably 7% or less, and most preferably 3% or less.

The reaction rate of the curing reaction (for example, a polymerization reaction) performed by the ultraviolet irradiation is preferably 60% or higher, more preferably 70% or higher, and even more preferably 80% or higher, from the viewpoint of retaining a mechanical strength of a layer or suppressing outflow of an unreacted substance from the layer. In order to improve the reaction rate, a method of increasing the irradiation dose of the ultraviolet ray to be emitted or polymerization under a nitrogen atmosphere or under heating conditions is effective. In addition, it is possible to use a method in which first, polymerization is performed, and then, the polymerizable compound is retained in a temperature state higher than a polymerization temperature, and thus, the reaction is further accelerated by the thermal polymerization reaction or a method in which an ultraviolet ray is emitted again. The reaction rate can be measured by comparing absorption intensities of an infrared vibration spectrum of a reactive group (for example, a polymerizable group) before and after the reaction.

<Stretching Step>

This step is a step of stretching the liquid crystal layer precursor layer 10P in the slow axis direction to form the liquid crystal layer 10 (phase difference film 1A). As described above, in a case where the liquid crystal layer precursor layer 10P is formed by a roll-to-roll process, the liquid crystal layer precursor layer 10P is formed such that the slow axis direction becomes a direction orthogonal to the film handling direction (TD direction). Accordingly, the stretching direction is the TD direction.

A method of stretching the liquid crystal layer precursor layer 10P in the TD direction is not particularly limited. For example, a method of stretching the liquid crystal layer precursor layer 10P by fixing both ends of the liquid crystal layer precursor layer with grips or pins and widening the interval between the clips or pins in a lateral direction, or a method of stretching the liquid crystal layer precursor layer in both longitudinal and lateral directions by simultaneously widening the interval between the clips or pins, and the like may be used. Needless to say, these methods may be used in combination. At this time, only the liquid crystal layer precursor layer 10P may be stretched or the liquid crystal layer precursor layer may be stretched with the base material 20. In addition, a so-called tenter method is preferable because in a case where the clip portion is driven by a linear drive system, smooth stretching can be performed.

A suitable range of the film surface temperature of the liquid crystal layer precursor layer 10P or the like in the stretching step is as described above.

In addition, in a case where the film is stretched in the TD direction (width direction), a distribution in refractive index may be generated in the width direction. The generation of the distribution may be observed, for example, in a case of using a tenter method, but this is a phenomenon occurring due to the fact that a contractile force is generated at the center portion of the film by stretching the film in the TD direction and the end portions are fixed, a so-called bowing phenomenon. In this case, by appropriately stretching the film in the film handling direction (MD direction) within a range in which the retardation value is not out of the range, the bowing phenomenon can be suppressed and a distribution in phase difference in the width direction can be reduced. In addition, in a case where there are variations in film thickness, the film may be appropriately stretched in the same manner in the MD direction for reducing the variation. Excessively large variations in film thickness cause unevenness in phase difference. The variation in the film thickness of the resin film is in a range of ±3% and preferably in a range of ±1%.

[Polarizing Plate and Display Device]

By forming the phase difference film 1A or 1B on a polarizer directly or by transfer or the like, a polarizing plate provided with a light leakage suppressing function suitable for, in particular, an IPS mode liquid crystal display device can be obtained.

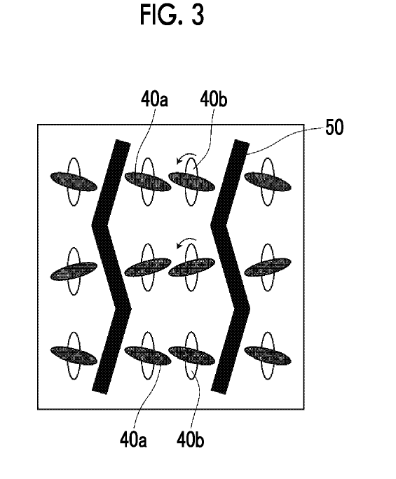

As shown in FIG. 3 described later, an IPS mode liquid crystal cell is in a mode in which liquid crystal molecules 40a and 40b are constantly rotated in the inner surface of a substrate, and is configured such that pixel electrodes 50 are arranged in only one direction of the substrate and apply a lateral electric field. In the IPS type, the liquid crystal molecules do not rise obliquely and thus, a relatively wide viewing angle can be obtained. However, in a case where a display device is viewed from a direction shifted from a direction normal to the substrate, a phenomenon that the viewing angle is narrowed by light leakage cannot be avoided. The phase difference films 1A and 1B are suitable as optically anisotropic layers that compensate for such a phenomenon.

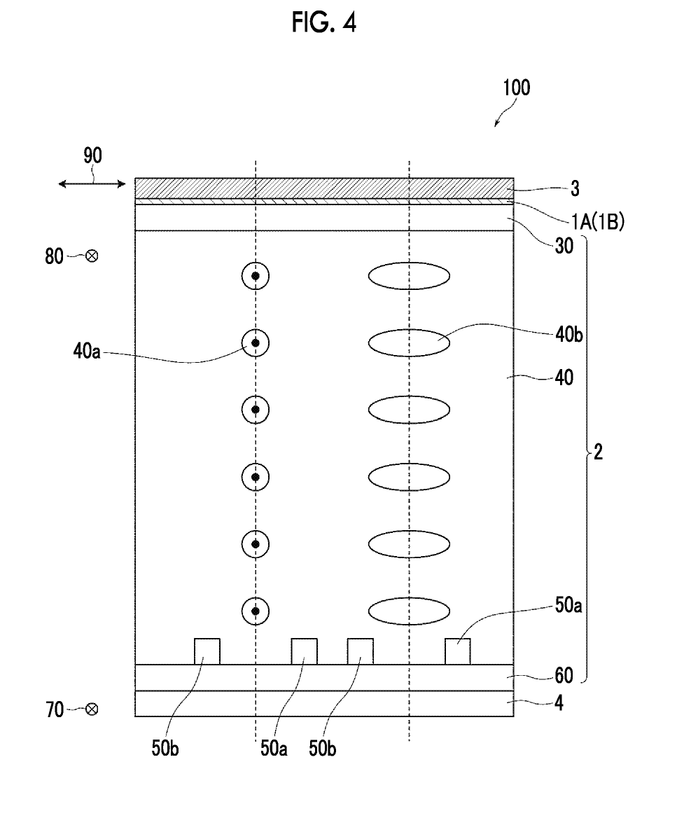

FIG. 3 is a schematic top view showing a part of pixel electrodes in the inner surface of a substrate of an IPS type liquid crystal cell, and FIG. 4 is a schematic cross-sectional view showing the configuration of an IPS type liquid crystal display device 100 including the phase difference film 1A (1B) on a polarizing plate 3 according to the embodiment.

The polarizing plate 3 includes the phase difference film 1A (1B) on the surface of a polarizer close to a liquid crystal cell 2. Although not shown in the drawing, a polarizing plate protective film may be provided on the surface of the polarizing plate 3 on a viewing side.

The polarizer is not particularly limited and any of an iodine-based polarizer, a dye-based polarizer using a dichroic dye, and a polyene-based polarizer may be used. The iodine-based polarizer and dye-based polarizer can be generally produced by immersing and stretching a polyvinyl alcohol-based film in an iodine solution.

In a case where the phase difference film 1A or 1B are used in a liquid crystal display device, as shown in the drawing, the phase difference film is preferably arranged between the liquid crystal cell and the viewing side polarizing plate or the phase difference film is preferably arranged between the liquid crystal cell and the backlight side polarizing plate. In addition, the phase difference film may be incorporated within the liquid crystal display device as a member of a polarizing plate and arranged between the liquid crystal cell and a polarizer, such that the phase difference film also functions as a protective film for the viewing side polarizing plate or the backlight side polarizing plate.

In a case where the phase difference film is utilized to optically compensate liquid crystal cells of the IPS mode (in particular, color shift reduction in the oblique direction during black display), the phase difference film may be used in combination with a positive A-plate.

A liquid crystal display device 100 shown in FIG. 4 includes a pair of polarizing plates (an upper polarizing plate 3 and a lower polarizing plate 4), and a liquid crystal cell 2 sandwiched between the polarizing plates, the liquid crystal cell 2 has a liquid crystal layer 40, a liquid crystal cell upper substrate 30 provided on the liquid crystal layer, and a liquid crystal cell lower substrate 60 provided below the liquid crystal layer, and the lower substrate 60 is provided with transparent pixel electrodes 50a and 50b. Although not shown in the drawing, a back light unit is provided under the polarizing plate 4 and a color filter is provided between the liquid crystal layer 40 and the viewing side polarizing plate 3.

The left side of FIG. 4 shows a state in which liquid crystal molecules 40a are in a voltage OFF state, and the right side shows a state in which liquid crystal molecules 40b are in a voltage ON state. In a case where voltage is turned ON, a voltage is applied between the pixel electrodes 50a and 50b, an electric field is generated, the liquid crystal molecules 40a rotate substantially simultaneously in a direction substantially horizontal with respect to the surface of the substrate to attain the state shown on the right side of FIG. 4. In FIG. 4, an absorption axis 70 of the backlight side polarizing plate 4 and an absorption axis 90 of the viewing side polarizing plate 3 are substantially orthogonal to each other, and in a case where voltage is turned OFF, a direction 80 of the optical axes of the liquid crystal molecules is substantially parallel to the absorption axis 70.

In the embodiment, it is preferable that phase difference layers other than the phase difference films 1A and 1B are not present between the display side polarizing plate and the backlight side polarizing plate and the liquid crystal cell. Accordingly, in a case where a polarizing plate protective film or the like is provided between the display side polarizing plate and the backlight side polarizing plate and the liquid crystal cell, it is preferable that an isotropic polymer film in which both the in-plane phase difference Re and the phase difference Rth in the film thickness direction are approximately 0 is used, and as such a polymer film, a cellulose acylate film described in JP2006-030937A is preferably used.

### Examples

Hereinafter, the present invention will be described in more detail with reference to examples. Materials, the amount of materials used and ratios thereof, treatment contents, treatment procedures, and the like in the following examples may be appropriately changed within a scope that does not depart from the spirit of the present invention. Accordingly, the range of the present invention will not be restrictively interpreted by the following specific examples.

Hereinafter, a method of preparing a phase difference film of Example 1 will be mainly described. Different preparation conditions (including materials, stretching ratios, and the like) and evaluation results of each Example and each Comparative Example will be collectively shown in Table 2.

┌Preparation of Base Material┘

<Base Material with Alignment Layer>

(Alkali Saponification Treatment of Cellulose Acylate Film Base Material)

A cellulose acylate film TI (“TD40UL”, manufactured by Fujifilm Corporation) was allowed to pass through dielectric heating rolls at a temperature of 60° C., the film surface temperature was increased to 40° C., and then, an alkali solution having a composition described below was applied to one surface of the film in a coating amount of 14 ml/m² by using a bar coater and hated to 110° C. The film was handled for 10 seconds under a steam type far infrared heater manufactured by NORITAKE CO., LIMITED. Subsequently, 3 ml/m² of pure water was applied by using the same bar coater. Next, water washing using a fountain coater and drainage using an air knife were repeated three times, and then, the film was dried by being handled into a drying zone at 70° C. for 10 seconds. Thus, a cellulose acylate film which had been subjected to an alkali saponification treatment was prepared as a base material.

Alkali Solution Composition

| | |
|---|---|
| Potassium hydroxide | 4.7 parts by mass |
| Water | 15.8 parts by mass |
| Isopropanol | 63.7 parts by mass |
| Surfactant (C₁₄H₂₉O(CH₂CH₂O)₂₀H) | 1.0 part by mass |
| Propylene glycol | 14.8 parts by mass |

(Formation of Alignment Layer)

An alignment film coating liquid having a composition described below was continuously applied onto a long cellulose acylate film which has been subjected to the saponification treatment as described above by using a wire bar of #14. The coating liquid was dried by hot air at 60° C. for 60 seconds, and further dried by hot air at 100° C. for 120 seconds to remove a solvent. The obtained coated film was continuously subjected to a rubbing treatment. At this time, a longitudinal direction and a handling direction of the long film were parallel to each other, and a rotation axis of the rubbing roller was parallel to a film width direction such that the slow axis of the liquid crystal layer precursor layer became the width direction. Thus, a base material with an alignment layer in which the alignment layer was provided on the cellulose acylate film was obtained.

Alignment Layer Coating Liquid Composition

| | |
|---|---|
| Modified polyvinyl alcohol below | 10.0 parts by mass |
| Water | 371.0 parts by mass |
| Methanol | 119.0 parts by mass |
| Glutaraldehyde | 0.5 parts by mass |
| Photopolymerization initiator (IN1) | 0.3 parts by mass |

(In the following structural formula, the percentage is a molar ratio.)

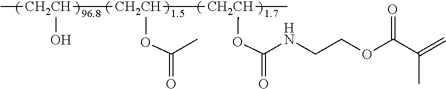

Modified Polyvinyl Alcohol

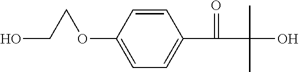 [SMILES: CC(C)(O)C(=O)c1ccc(OCCO)cc1]

<Preparation of Liquid Crystal Layer Precursor Layer>

A composition for forming a liquid crystal layer precursor layer was continuously applied to the alignment layer of the base material with the alignment layer by using a wire bar of #7.2. The handling velocity (V) of the film was set to 20 m/min. In order to dry the solvent of the coating liquid and to perform alignment and aging with respect to the disk-like liquid crystal compound, heating was performed by hot air at 130° C. for 90 seconds. Subsequently, ultraviolet irradiation (200 mJ/cm²) was performed at 75° C. and thus, a liquid crystal layer precursor layer was prepared by fixing the alignment of the liquid crystal compound.

The liquid crystal compounds and the base materials used in each Example and each Comparative Example are as shown in Table 2.

Hereinafter, the chemical composition of a composition for forming a liquid crystal layer precursor layer used in each Example and each Comparative Example excluding Example 6 and Comparative Example 4 is shown. Regarding a composition for forming a liquid crystal layer precursor layer of Example 6, Compounds 101 and 102 in the composition described below were substituted with Compounds 1 and 2.

<Composition for Forming Liquid Crystal Layer Precursor Layer>

| | |
|---|---|
| Disk-like liquid crystal compound 101 | 80.00 parts by mass |
| Disk-like liquid crystal compound 102 | 20.00 parts by mass |
| Alignment auxiliary agent (Chemical formula | 0.90 parts by mass |
| OA1) | |
| Alignment auxiliary agent (Chemical formula | 0.10 parts by mass |
| OA2) | |
| Surfactant (Chemical formula SA1, molecular | 0.10 parts by mass |
| weight of 628) | |
| Polymerization initiator (Chemical formula | 3.00 parts by mass |
| IN2) | |
| Methyl ethyl ketone | 301.00 parts by mass |

Each of the alignment auxiliary agents OA1 and OA2 was a mixture of two compounds (mixing mass ratio: 50:50) having different substituted positions of a methyl group in a benzene ring substituted with trimethyl in the following structural formulae.

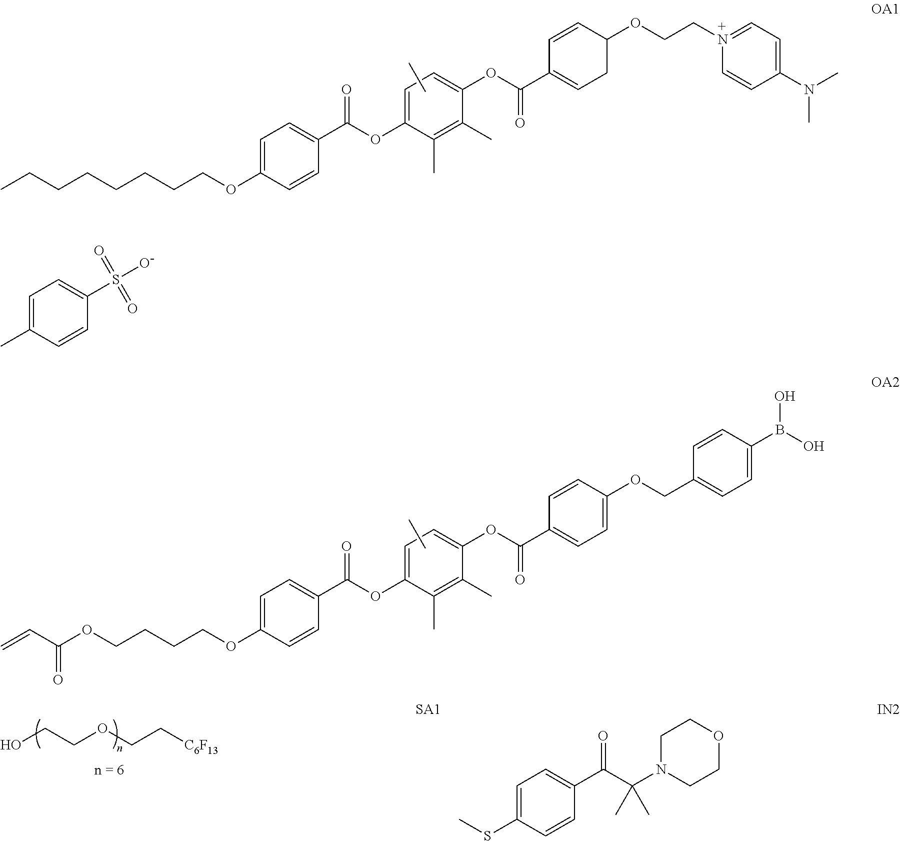

<Stretching Step>

Next, the film in which the liquid crystal layer precursor layer was provided on the base material was fixed and was uniaxially stretched at 180° C. in the slow axis direction at a stretching ratio shown in Table 2, and a phase difference film in each of Examples and Comparative Examples was formed. The slow axis was measured by making light having a wavelength of 550 nm to be incident on the film in a direction normal to the film using KOBRA 21ADH (manufactured by Oji Scientific Instruments). At this time, the handling direction (longitudinal direction) of the film was set to 90°, and a direction orthogonal to the handling direction (width direction) was set to 0°. The stretching speed was set to 30%/min.

The phase difference film obtained as described above was laminated on the following polarizing plate.

(Preparation of Polarizing Plate)

<Preparation of Polarizing Film>

A polyvinyl alcohol (PVA) film having a thickness of 80 μm was immersed in an aqueous iodine solution having an iodine concentration of 0.05% by mass at 30° C. for 60 seconds and dyed. Next, while the film was being immersed in an aqueous boric acid solution having a boric acid concentration of 4% by mass for 60 seconds, the length of the film was longitudinally stretched by 5 times of the original length, and then, the film was dried at 50° C. for 4 minutes to obtain a polarizing film having a thickness of 20 μm.

<Preparation of Polarizing Film Protective Film>

As a polarizing film protective film, TJ25 (25 μm TAC) manufactured by Fujifilm Corporation was used. The polarizing film protective film was immersed in an aqueous sodium hydroxide solution of 1.5 mol/liter at 55° C. and then sodium hydroxide was fully washed away with water. After the film was immersed in an aqueous sulfuric acid solution of 0.05 mol/liter at 35° C. for 1 minute and immersed in water, the aqueous sulfuric acid solution was fully washed away with water. Finally, the sample was fully dried at 120° C. and the polarizing plate protective film was subjected to a saponification treatment.

The polarizing film prepared above and the polarizing film protective film were laminated using a polyvinyl alcohol-based adhesive and dried at 70° C. for 10 minutes or longer to obtain a polarizing plate.

<Lamination of Phase Difference Film and Polarizing Plate>

There are two kinds of methods of laminating the phase difference film to the polarizing plate: transfer lamination and direct lamination. Regarding the lamination method in each of Examples and Comparative Examples, in Table 2, the method is expressed as “transfer” or “direct”.

First, the lamination method by transfer applied in Example 1 will be described. The lamination by transfer was performed such that the surface of the polarizing plate not provided with the polarizing film protective film was laminated on the surface of the phase difference film close to the liquid crystal layer through a pressure sensitive adhesive (manufactured by Soken Chemical & Engineering Co., Ltd., SK DYNE 2057) and the base material of the phase difference film was peeled off.

Next, the lamination method by direct lamination will be described. After the phase difference film was immersed in an aqueous sodium hydroxide solution of 1.5 mol/L at 55° C., sodium hydroxide was fully washed away with water. After the film was immersed in an aqueous sulfuric acid solution of 0.05 mol/L at 35° C. for 1 minute, the film was immersed in water and the aqueous sulfuric acid solution was fully washed away with water. Finally, the sample was fully dried at 120° C. and the phase difference film was subjected to a saponification treatment. Then, the surface of the polarizing plate having the polarizing plate protective film provided on one surface thereof, on which the polarizing plate protective film was not provided, and the surface of the phase difference film close to the base material were laminated using a polyvinyl alcohol-based adhesive and the laminate was dried at 70° C. for 10 minutes to perform direct lamination.

In a case where the phase difference film and the polarizing plate were laminated, the phase difference film and the polarizing plate were arranged such that the transmission axis of the polarizer and the slow axis of the phase difference film were parallel to each other. In addition, the polarizer and a commercially available cellulose triacetate film were arranged such that the transmission axis of the polarizer and the slow axis of the cellulose triacylate film were orthogonal to each other.

Hereinafter, examples to which different materials and method from the materials and method in Example 1 are applied will be described.

<Base Material of Example 9>

In Example 9, as the base material, ZRD40 (manufactured by Fujifilm Corporation (40 μm zero retardation TAC)) was used.

<Base Material of Example 10 and Example 11>

A PMMA base material used in Examples 10 and 11 (polymethyl methacrylate base material), a base material produced in the following manner was used.

(Preparation of Resin)

First, an acrylic resin (PMMA resin) having a weight-average molecular weight of 1,300,000 and a MMA ratio of 100% was synthesized in the following method.

Into a 1 L three-necked flask equipped with a mechanical stirrer, a thermometer, a cooling pipe, 300 g of ion exchange water and 0.6 g of polyvinyl alcohol (degree of saponification: 80%, degree of polymerization: 1,700) were poured and the flask was stirred to completely dissolve polyvinyl alcohol. Then, 100 g of methyl methacrylate and 0.15 g of azobisisobutyronitrile were added thereto and were allowed to react at 85° C. for 6 hours. The obtained suspension was filtered by a nylon filter cloth and was washed with methanol, and the filtrate was dried at 50° C. overnight to obtain a desired polymer in the form of beads.

(Dissolving Step: Preparation of Dope Composition)

The composition described below was put into a mixing tank and stirred while being heated and each component was dissolved to prepare a dope composition.

(Dope Composition)

| | |
|---|---|
| PMMA resin | 100 parts by mass |
| Antioxidant | 0.1 parts by mass |
| Dichloromethane | 383 parts by mass |
| Methanol | 57 parts by mass |

As the antioxidant, SUMILIZER GS (manufactured by Sumitomo Chemical Company, Limited) was used.

(Preparation of Film)

The dope composition prepared as described above was uniformly cast on a stainless steel band (casting support) from a casting die. At the time when the amount of the residual solvent in the casting film reached 20% by mass, the composition was peeled off from the casting support as a casting film. The both end portions of the peeled-off casting film in the width direction were gripped by a tenter. The peeled-off casting film was dried at 120° C. for 10 minutes and then was subjected to a heat treatment at 220° C. for 20 minutes. After the heat treatment, the film was stretched by 1.18 times at 180° C. to obtain a PMMA film having a thickness of 40 μm.

In Examples 9, 10, and 11, each phase difference film was formed by preparing a base material with an alignment layer using each base material in the same procedure except that the base materials were different from the base material in Example 1 described above.

The chemical composition of a composition for forming a liquid crystal layer precursor layer used in Comparative Example 4 is shown.

<Composition for Forming Liquid Crystal Layer Precursor Layer in Comparative Example 4>

| | |
|---|---|
| Rod-like liquid crystal compound (Chemical | 83.00 parts by mass |
| formula R1) | |
| Rod-like liquid crystal compound (Chemical | 15.00 parts by mass |
| formula R2) | |
| Rod-like liquid crystal compound (Chemical | 2.00 parts by mass |
| formula R3) | |
| Multifunctional monomer A-TMMT | 1.00 part by mass |
| (manufactured by Shin-Nakamura Chemical | |
| Co., Ltd.) | |
| Polymerization initiator (Chemical formula | 4.00 parts by mass |
| IN3) | |
| Surfactant (SA7, molecular weight: 6,600) | 0.15 parts by mass |
| Methyl ethyl ketone | 165.00 parts by mass |
| Cyclohexanone | 10.00 parts by mass |

The rod-like liquid crystal compounds used in Comparative Example 4 are as follows.

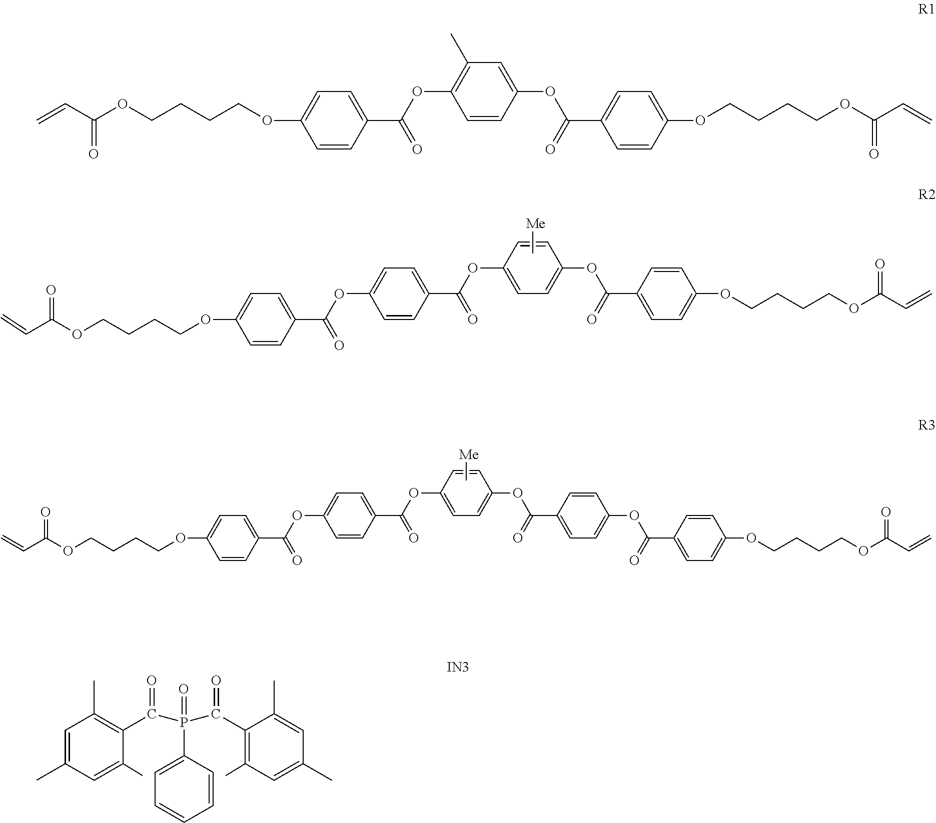

The composition for forming a liquid crystal layer precursor layer including the rod-like liquid crystal compounds of the composition continuously applied to the alignment layer of the same base material with the alignment layer as in Example 1 by using a wire bar of #7.2. The handling velocity (V) of the film was set to 20 m/min. In order to dry the solvent of the coating liquid and to perform alignment and aging with respect to the rod-like liquid crystal compounds, heating was performed by hot air at 60° C. for 90 seconds. Subsequently, ultraviolet irradiation (300 mJ/cm²) was performed at 40° C. and thus, a liquid crystal layer precursor layer was formed by fixing the alignment of the liquid crystal compound.

<Properties of Film>

(Film Thickness)

The reflectivity was measured using an interference film thickness measuring device (FE3000 manufactured by Otsuka Electronics Co., Ltd.) at a lens magnification of 25 times. The refractive index of each of the base material, the alignment film, and the liquid crystal layer at a wavelength of 400 nm to 800 nm was calculated by a base analysis method, and fitting was performed by an optimization method using the calculated refractive index at a wavelength of 400 nm to 800 nm to calculate the film thickness. In Table 2, the unit of the film thickness is [μm].

(Phase Difference (Retardation))

Regarding the phase difference film prepared in each of Examples and Comparative Examples, the in-plane retardation Re was obtained by three-dimensional birefringence measurement at a wavelength of 550 nm by the above-described method using an automatic birefringence meter KOBRA-WR (manufactured by Oji Scientific Instruments), and the retardation Rth in the film thickness direction was obtained by measuring Re while changing the tilt angle. In addition, Nz=(nx−nz)/(nx−ny)=Rth/Re+0.5 was obtained at the same time.

In table 2, the unit of both Re and Rth is [nm].

(Evaluation of Light Leakage During Black Display (Black Brightness))

The polarizing plate provided with the phase difference film was mounted in an IPS mode liquid crystal display device and a backlight was arranged. Using a measurement machine (EZ-Contrast XL88, manufactured by ELDIM Co., Ltd.), the brightness as observed in a direction of a polar angle of 60 degrees with respect to the front surface in black display at an azimuthal angle of 0 to 360 degrees was measured and the measured brightness was evaluated based on the following standards.

A: The maximum value of brightness was less than 0.70×10⁻⁴.

B: The maximum value of brightness was 0.70×10⁻⁴ or more and less than 1.00×10⁻⁴.

C: The maximum value of brightness was 1.00×10⁻⁴ or more.

TABLE 2

| | | | | | | | | Base | |
|---|---|---|---|---|---|---|---|---|---|
| | | | | | Liquid crystal layer | | | material + liquid | Light leakage |
| | Lamination | | Base | Stretching | Film thickness | | | crystal layer | evaluation |
| | method | Liquid crystal compound | material | ratio | after stretching | Re | Rth | Nz | Black brightness |
| Comparative | Transfer | Compounds 101 and 102 | TD40 | 1.28 | 1.4 | 180 | −30 | 0.33 | C |
| Example 1 | | | | | | | | | |
| Example 1 | Transfer | Compounds 101 and 102 | TD40 | 1.28 | 1.6 | 200 | −30 | 0.35 | B |
| Example 2 | Transfer | Compounds 101 and 102 | TD40 | 1.40 | 1.6 | 200 | −11 | 0.45 | B |
| Example 3 | Transfer | Compounds 101 and 102 | TD40 | 1.40 | 2.0 | 250 | −13 | 0.45 | B |
| Comparative | Transfer | Compounds 101 and 102 | TD40 | 1.26 | 1.8 | 230 | −39 | 0.33 | C |
| Example 2 | | | | | | | | | |
| Example 4 | Transfer | Compounds 101 and 102 | TD40 | 1.31 | 1.9 | 240 | −29 | 0.38 | B |
| Example 5 | Transfer | Compounds 101 and 102 | TD40 | 1.37 | 2.4 | 300 | −23 | 0.42 | B |
| Comparative | Transfer | Compounds 101 and 102 | TD40 | 1.34 | 2.6 | 320 | −30 | 41.00 | C |
| Example 3 | | | | | | | | | |
| Example 6 | Transfer | Compounds 1 and 2 | TD40 | 1.36 | 2.0 | 250 | −20 | 0.42 | B |
| Comparative | Transfer | Compounds R1, R2 and R3 | TD40 | 1.28 | 1.0 | 20 | −125 | −5.75 | C |
| Example 4 | | | | | | | | | |
| Comparative | Transfer | Compounds 101 and 102 | TD40 | 0 | 2.0 | 250 | −125 | 0.00 | C |
| Example 5 | | | | | | | | | |
| Example 7 | Direct | Compounds 101 and 102 | TD40 | 1.36 | 2.7 | 250 | −20 | 0.54 | A |
| Example 8 | Direct | Compounds 101 and 102 | TD40 | 1.28 | 1.6 | 200 | −30 | 0.50 | A |
| Example 9 | Direct | Compounds 101 and 102 | ZRD40 | 1.36 | 2.7 | 250 | −20 | 0.42 | B |
| Example 10 | Direct | Compounds 101 and 102 | PMMA | 1.28 | 1.6 | 200 | −30 | 0.35 | B |
| Example 11 | Direct | Compounds 101, and 102 | PMMA | 1.40 | 2.0 | 250 | −13 | 0.45 | B |

In all of Examples, the evaluation standard in the black brightness was B or higher.

### EXPLANATION OF REFERENCES

1, 1A, 1B: phase difference film
2: liquid crystal cell
10: liquid crystal layer
20: base material
3, 4: polarizing plate
30: liquid crystal cell upper substrate
40: liquid crystal layer
50: pixel electrode
60: liquid crystal cell lower substrate
100: liquid crystal display device (display device)

What is claimed is:

1. A phase difference film comprising:
a liquid crystal layer in which a disk-like liquid crystal compound is fixed in a homeotropic alignment state,
wherein an in-plane retardation Re of the liquid crystal layer satisfies 200 nm≤Re≤300 nm and a retardation Rth thereof in a thickness direction satisfies −30 nm≤Rth.

2. The phase difference film according to claim 1,
wherein the liquid crystal layer is provided on a cellulose acylate film base material, and
an Nz coefficient satisfies 0.50≤Nz.

3. The phase difference film according to claim 1,
wherein the disk-like liquid crystal compound includes Compound 101 or Compound 102.

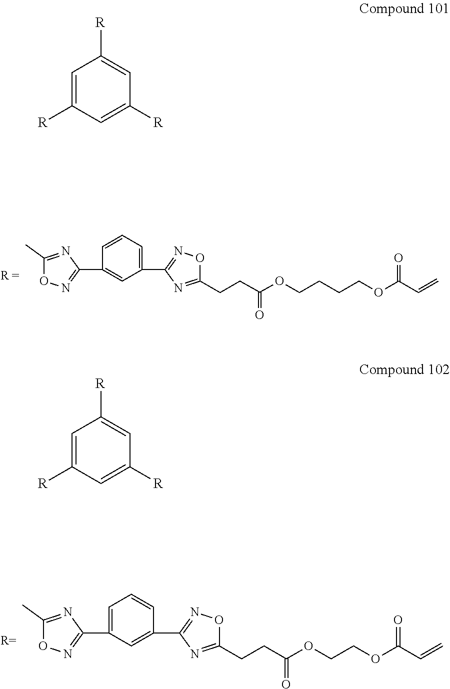

4. The phase difference film according to claim 2,
wherein the disk-like liquid crystal compound includes Compound 101 or Compound 102.

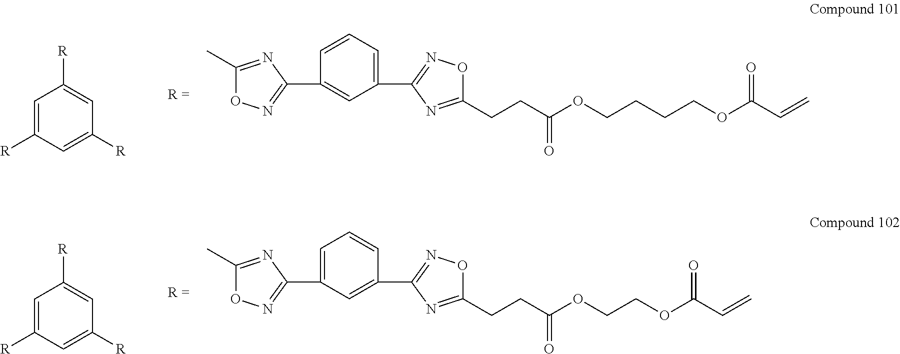

5. A method of producing a phase difference film, comprising:
a liquid crystal layer precursor layer forming step of forming a liquid crystal alignment film in which a disk-like liquid crystal compound is aligned in a homeotropic manner and then fixing the disk-like liquid crystal compound to form a liquid crystal layer precursor layer; and
a stretching step of stretching the liquid crystal layer precursor layer in a slow axis direction.

6. The method of producing a phase difference film according to claim 5,
wherein in the stretching step, a stretching ratio is 1.28 to 1.40 times.

7. The method of producing a phase difference film according to claim 5,
wherein in the stretching step, a film surface temperature of the liquid crystal layer precursor layer is set to be equal to or higher than a glass transition temperature and equal to or lower than a melting temperature of the liquid crystal layer precursor layer.

8. The method of producing a phase difference film according to claim 6,
wherein in the stretching step, a film surface temperature of the liquid crystal layer precursor layer is set to be equal to or higher than a glass transition temperature and equal to or lower than a melting temperature of the liquid crystal layer precursor layer.

9. The method of producing a phase difference film according to claim 5,
wherein the disk-like liquid crystal compound includes Compound 101 or Compound 102.

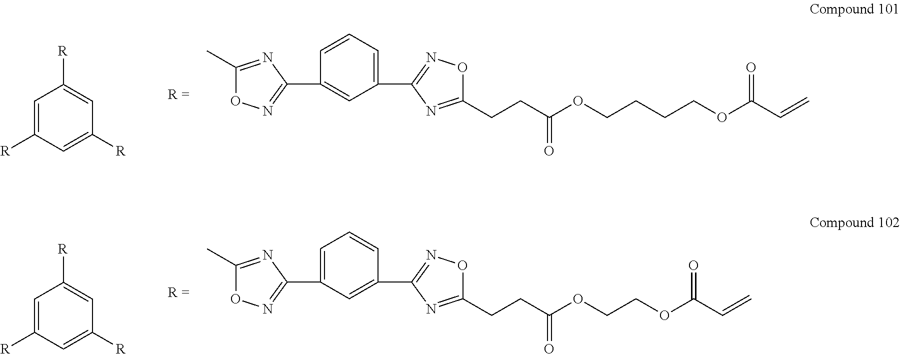

10. The method of producing a phase difference film according to claim 6,
wherein the disk-like liquid crystal compound includes Compound 101 or Compound 102.

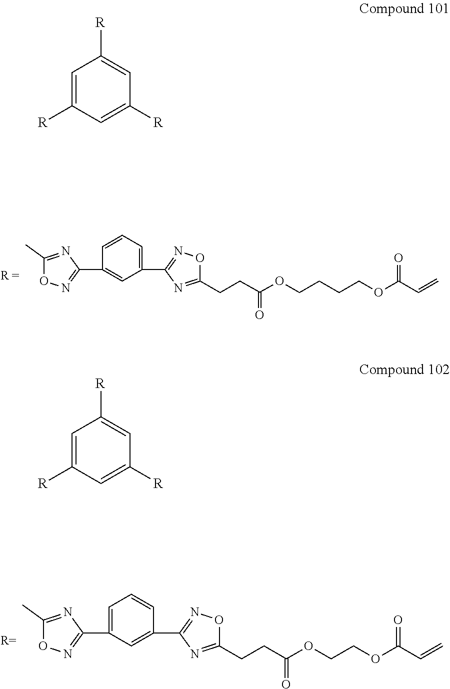

11. The method of producing a phase difference film according to claim 7,
wherein the disk-like liquid crystal compound includes Compound 101 or Compound 102.

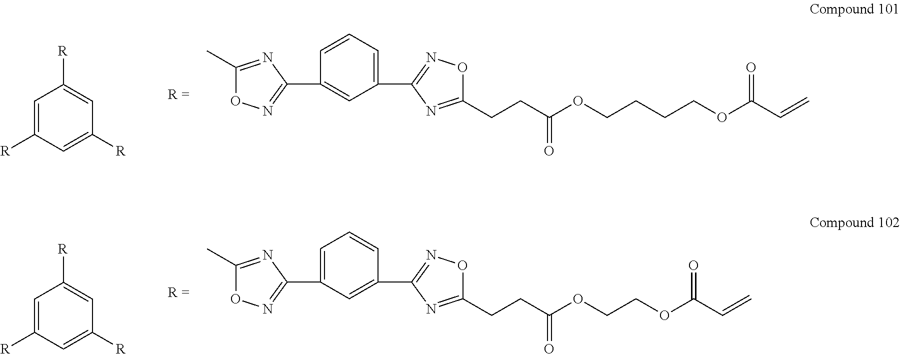

12. A phase difference film produced by the method of producing a phase difference film according to claim 5.

13. A polarizing plate comprising:
the phase difference film according to claim 1.

14. A liquid crystal display device comprising:
A liquid crystal cell, and
the polarizing plate according to claim 13.
